(19) United States
(12) Patent Application Publication
(10) Pub. No.: US 2022/0156382 A1
(43) Pub. Date: May 19, 2022

(54) INFORMATION PROCESSING DEVICE, INFORMATION PROCESSING METHOD, AND COMPUTER PROGRAM PRODUCT

(71) Applicant: KABUSHIKI KAISHA TOSHIBA, Tokyo (JP)

(72) Inventors: Naoki OGURA, Yokohama (JP); Satoshi AOKI, Kawasaki (JP); Yoshikazu HANATANI, Komae (JP); Hiroyoshi HARUKI, Kawasaki (JP)

(73) Assignee: KABUSHIKI KAISHA TOSHIBA, Tokyo (JP)

(21) Appl. No.: 17/461,056

(22) Filed: Aug. 30, 2021

(30) Foreign Application Priority Data
Nov. 18, 2020 (JP) 2020-191822

(51) Int. Cl. G06F 21/57

(52) U.S. Cl. CPC G06F 21/577; G06F 2221/034

(57) ABSTRACT

According to an embodiment, an information processing device includes one or more processors. The one or more processors are configured to: acquire one or more pieces of setting information of a module used for an attack aimed at a target of a penetration test; analyze the acquired setting information to determine a type of the attack; and generate attack step information that defines a condition and a procedure of the attack according to the determined type.

### CROSS-REFERENCE TO RELATED APPLICATIONS

This application is based upon and claims the benefit of priority from Japanese Patent Application No. 2020-191822, filed on Nov. 18, 2020; the entire contents of which are incorporated herein by reference.

### FIELD

An embodiment described herein relates generally to an information processing device, an information processing method, and a computer program product.

### BACKGROUND

Recently, there are more and more cyberattacks aimed at industrial control systems of factories and power plants, causing serious business and human damages. For determining the security state of the system, it is considered effective to conduct a penetration test. By conducting the penetration test, it is possible to find security weaknesses and repair the system to be able to withstand the cyberattacks.

In the cyberattack aimed at a control system, an attacker implements manipulation, information leakage, destruction, and the like as the ultimate goal by using a plurality of devices and a plurality of vulnerabilities. Information that defines the devices and vulnerabilities used by the attacker to achieve the ultimate goal is called an attack scenario. In the penetration test, an attack scenario is created for performing a simulation of a cyberattack.

Creating an attack scenario requires a database (attack database) carrying description of information (attack step information) that contains attack conditions (preconditions) required for exploiting vulnerabilities of each device and effects (postconditions) when the vulnerabilities are exploited. However, the conventional techniques have not disclosed any method for generating an attack database, so that an engineer who has expertise in such attacks, for example, needs to generate the attack database manually.

It is an object of the present invention to provide an information processing device, an information processing method, and a computer program product, which are capable of more efficiently generating information used for a penetration test.

### BRIEF DESCRIPTION OF THE DRAWINGS

FIG. 1 is a block diagram of an information processing device according to an embodiment;

FIG. 2 is a flowchart of a penetration test;

FIG. 3 is a schematic diagram for describing an example of attack step information;

FIG. 4 is a diagram illustrating an example of attack step information for “bluekeep”;

FIG. 5 is a schematic diagram illustrating an example of argument information;

FIG. 6 is a schematic diagram illustrating an example of an option;

FIG. 7 is a schematic diagram illustrating an example of a payload;

FIG. 8 is a flowchart of analysis processing performed by an analysis module;

FIG. 9 is a flowchart of generation processing;

FIG. 10 is a flowchart of generation processing;

FIG. 11 is a flowchart of generation processing;

FIG. 12 is a flowchart of generation processing; and

FIG. 13 is a hardware configuration diagram of the information processing device.

### DETAILED DESCRIPTION

According to an embodiment, an information processing device includes one or more processors. The one or more processors are configured to: acquire one or more pieces of setting information of a module used for an attack aimed at a target of a penetration test; analyze the acquired setting information to determine a type of the attack; and generate attack step information that defines a condition and a procedure of the attack according to the determined type.

A preferred embodiment of an information processing device according to the present invention will be described hereinafter in detail with reference to the accompanying drawings.

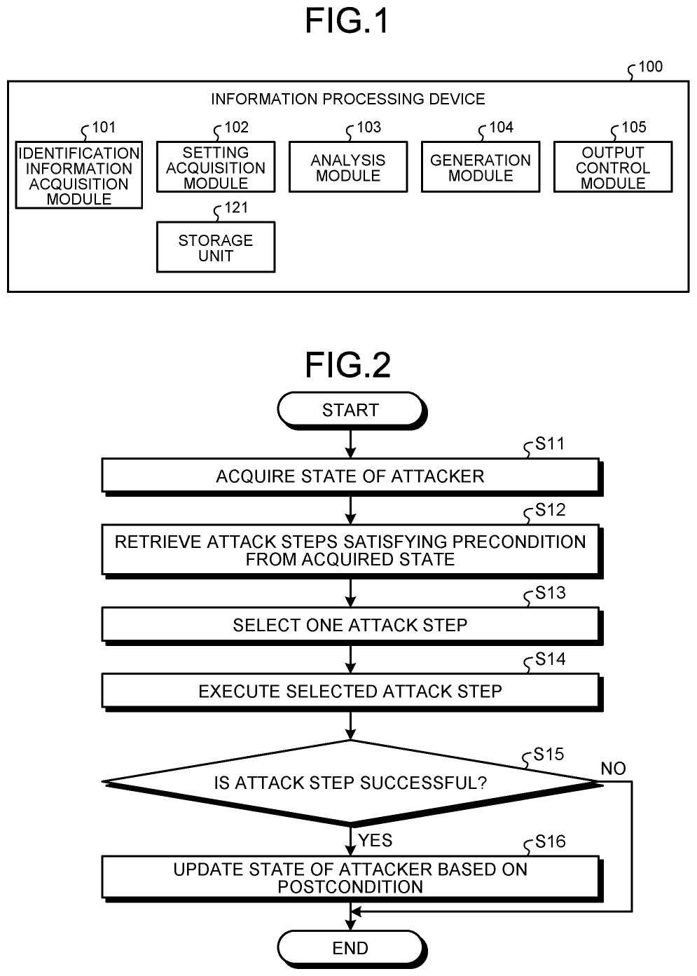

FIG. 1 is a block diagram illustrating an example of a configuration of an information processing device 100 according to the embodiment. As illustrated in FIG. 1, the information processing device 100 includes a storage unit 121, an identification information acquisition module 101, a setting acquisition module 102, an analysis module 103, a generation module 104, and an output control module 105.

The storage unit 121 stores therein various kinds of information used in various kinds of processing performed by the information processing device 100. For example, the storage unit 121 stores therein information regarding exploits. An exploit is a module used for an attack aimed at a target of a penetration test, and examples thereof may be a Metasploit module, a Proof of Concept (PoC) code, and the like. Metasploit is an open source project for implementing a penetration test and the like. For example, the storage unit 121 stores therein a package of Metasploit including a set of modules of Metasploit.

The storage unit 121 may be configured with any desired recording mediums used in general, such as a flash memory, a memory card, a Random Access Memory (RAM), a Hard Disk Drive (HDD), and an optical disc.

The identification information acquisition module 101 acquires identification information of the exploit as a generation target of attack step information used for a penetration test. Examples of the identification information of the exploit include Common Vulnerability and Exposures (CVE) number, general name of vulnerability (specifically, bluekeep or the like), and name of Metasploit module. For example, the identification information acquisition module 101 acquires identification information of the exploit from a user of the information processing device 100.

The setting acquisition module 102 acquires one or more pieces of setting information of the exploit corresponding to the identification information of the exploit. For example, the setting acquisition module 102 acquires, from the storage unit 121, setting information corresponding to the identification information acquired by the identification information acquisition module 101.

The setting information is information indicating setting for the exploit to be executed, and includes information indicating arguments to be given to the module of the exploit (argument information, input argument), for example. Hereinafter, a case of using argument information as the setting information will be mainly described. Details of the setting information (argument information) will be described later.

For example, a package of the exploit such as Metasploit may include a function of returning the argument information that corresponds to designated identification information. The setting acquisition module 102 acquires the argument information corresponding to the identification information by using such a function. An acquisition method of the argument information is not limited thereto but any method may be employed as long as it is capable of acquiring the argument information corresponding to the identification information. For example, it is possible to employ a configuration in which the storage unit 121 stores therein the identification information of the exploit and the argument information indicating the argument of the exploit in an associated manner, and the setting acquisition module 102 retrieves and acquires the argument information corresponding to the designated identification information from the storage unit 121.

The analysis module 103 analyzes the acquired setting information, and determines the type of attack (type of exploit). For example, the analysis module 103 determines the types defined in accordance with combinations of one or more pieces of setting information. Examples of the types of exploits include Remote Code Execution (RCE), Browser RCE, File Open RCE, and Privilege Escalation (PE). Note that these types are examples, and other types may be determined as well.

RCE is an attack exploiting the vulnerability of a service of a remote host. Browser RCE is an attack exploiting the vulnerability of a browser. For example, as for Browser RCE, an attack step is executed when a user opens a browser and views a website prepared by an attacker. File Open RCE is an attack where an attacker intrudes when a user opens an unauthorized file. PE is an attack for escalating a privilege to an administrator privilege in an already intruded host.

The generation module 104 generates attack step information according to the determined type of exploit. The attack step information is information that defines conditions and procedure of the attack. For example, the attack step information includes a precondition required before executing the attack, information indicating an operation of the module, and a postcondition satisfied after executing the attack. Details of the attack step information will be described later.

The output control module 105 controls output of various kinds of information. For example, the output control module 105 outputs generated attack step information to the user. The output of the attack step information may be in any desired forms. For example, in some output form, the attack step information may be stored in a database, output to a file, or displayed on a display device such as a display, each of which can be accessed by the user.

Each of the above-described units (the identification information acquisition module 101, the setting acquisition module 102, the analysis module 103, the generation module 104, and the output control module 105) may be implemented by one of more processors, for example. For example, each of the above-described units may be implemented by allowing a processor such as a Central Processing Unit (CPU) to execute a computer program, specifically, may be implemented by software. Each of the above-described units may be implemented by a processor such as a dedicated Integrated Circuit (IC), specifically, may be implemented by hardware. Each of the above-described units may be implemented by using both software and hardware. When a plurality of processors are used, each processor may implement one of those units or may implement two or more of those units.

Next, an example of the penetration test utilizing an attack database will be described. FIG. 2 is a flowchart illustrating an example of a part of flow of penetration test processing.

The information processing device 100 executing the penetration test checks the state of a current attacker (step S11). The state of the current attacker includes the following information acquired in a process of conducting the penetration test, for example.
Information of a host that has been discovered
Information of a host that has been successfully intruded
Information on an acquired credential and the like

The information processing device 100 retrieves one or more attack steps satisfying the precondition from an attack database based on the state of the current attacker (step S12).

The information processing device 100 selects one attack step from the retrieved attack steps (step S13). The information processing device 100 executes the selected attack step (step S14).

The information processing device 100 determines whether the executed attack step is successful (step S15). When the attack step succeeds (Yes at step S15), the information processing device 100 updates the state of the attacker based on the postcondition of the attack step (step S16). When the attack step fails (No at step S15) and after the state is updated, the penetration test is ended.

As described above, the penetration test requires the attack database in which information indicating sets of preconditions, operations (referred to as actions hereinafter) to be executed, and postconditions of each of the attack steps is written.

In the above, a device that actually executes the attack steps is described as an example of the information processing device 100 that requires the attack database. However, the device requiring the attack database is not limited thereto. For example, a cyberattack simulator device to which an initial condition of an attacker and the goal of the attack are supplied to simulate the actions considered to be taken by the attacker requires an attack database.

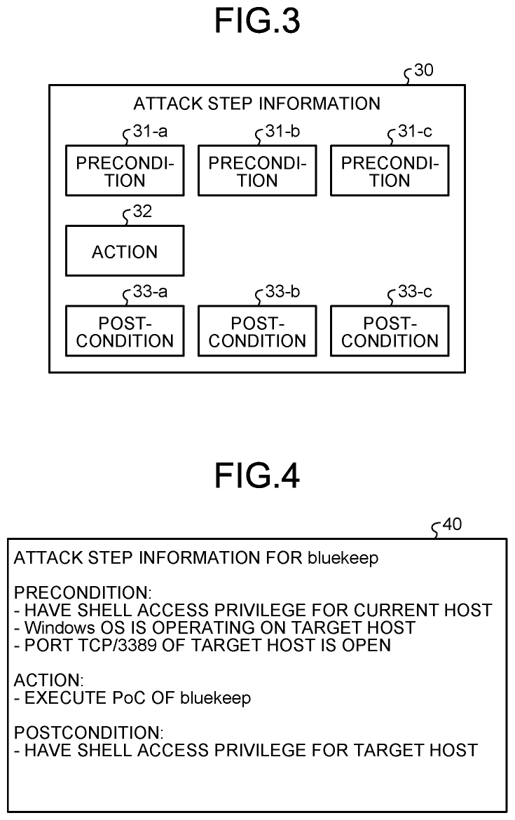

Next, attack step information will be described. FIG. 3 is a schematic diagram for describing an example of the attack step information. Attack step information 30 includes preconditions 31-a, 31-b, 31-c, an action 32, and postconditions 33-a, 33-b, 33-c.

The preconditions 31-a, 31-b, and 31-c are conditions to be satisfied in advance for successfully executing the attack step. FIG. 3 illustrates a case in which three preconditions 31-a, 31-b, and 31-c are defined. The number of preconditions is not limited thereto, but may be one, two, four or more. Hereinafter, the preconditions 31-a, 31-b, and 31-c may simply be referred to as preconditions 31 when there is no need to distinguish them.

As the preconditions 31, the following conditions may be used, for example.
Have shell access privilege for the current host
Specific operating system (OS) is operating on a target host
Specific port of a target host is open
User using a target host accesses a website with a browser
User using a target host opens a file

The action 32 is information regarding designation of a computer program executed when executing the attack step and the argument of the computer program, for example. FIG. 3 illustrates an example in which a single action 32 is defined. The number of actions is not limited thereto but may be two or more.

The action depends on the procedure assumed in executing the attack step. For example, when it is assumed that the attack step executes a module of Metasploit, the name of the module of Metasploit, options requiring input, and a payload requiring input are written in the action. For example, assuming that the attack step executes a program written in a programming language such as C, Java (registered trademark), Python, Ruby, or PHP on a command line, the program file name and argument information are written in the action.

The postconditions 33-a, 33-b, and 33-c are the state of the attacker to be satisfied anew when the attacker successfully executes the attack step. FIG. 3 illustrates a case in which three postconditions 33-a, 33-b, and 33-c are defined. The number of postconditions is not limited thereto, but may be one, two, four or more. Hereinafter, the postconditions 33-a, 33-b, and 33-c may simply be referred to as postconditions 33 when there is no need to distinguish them.

As the postconditions 33, the following conditions may be used, for example.
Have shell access privilege for a target host
Have shell access under administrator privilege of a target host

Next, a specific example of the attack step information will be described. FIG. 4 is a diagram illustrating an example of the attack step information of the attack step exploiting the vulnerability called “bluekeep”.

Attack step information 40 illustrated in FIG. 4 includes three preconditions, one action, and one postcondition. In the preconditions of FIG. 4, it is indicated that “have shell access for the current host”, “OS of the target host accessible from the current host is Windows (registered trademark)”, and “TCP port 3389 of the target host is open” are preconditions for achieving an attack exploiting bluekeep vulnerability.

In the action in FIG. 4, it is indicated to execute PoC code of bluekeep. In the postcondition illustrated in FIG. 4, it is indicated that the shell access privilege for the target host can be acquired when the attack exploiting the bluekeep vulnerability is executed and succeeded.

While the preconditions, the action, and the postcondition are written in a natural language in FIG. 4, those may also be written in other forms. For example, the preconditions, the action, and the postcondition may be written by using eXtensible Markup Language (XML), JavaScript (registered trademark) Object Notation (JSON), YAML Ain't Markup Language (YAML), Planning Domain Definition Language (PDDL), and the like. Furthermore, character strings expressing variables (for example, $current_host and the like) may be used for indicating items the values of which are settled at the time of generation of the attack scenario, such as the current host and the target host.

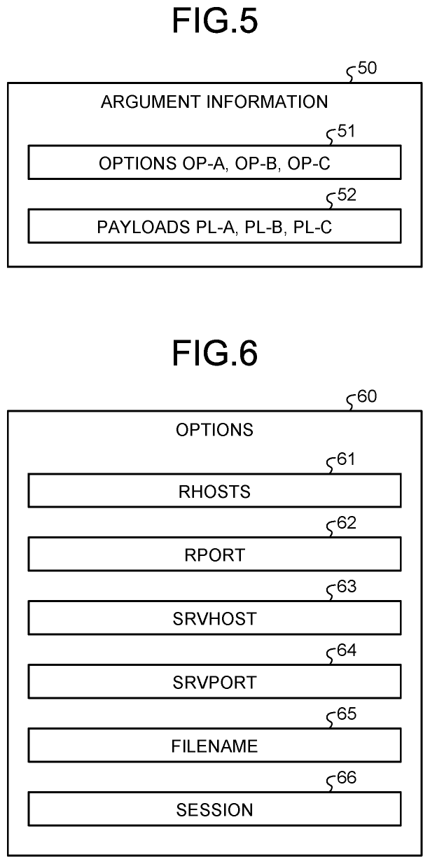

Next, the argument information will be described. FIG. 5 is a schematic diagram illustrating an example of argument information 50. The argument information 50 includes an option 51 and a payload 52.

The option 51 is a parameter considered to be required for executing the exploit, and it is input at the time of execution of the exploit. In FIG. 5, three options OP-A, OP-B, and OP-C are written. The number of options is not limited to three, but may be one, two, four or more.

The payload 52 is a code that is executed when intrusion is succeeded by execution of the exploit, and the code is input at the time of execution of the exploit. In FIG. 5, three payloads PL-A, PL-B, and PL-C are written. The number of payloads is not limited to three, but may be one, two, four or more.

Next, details of the option will be described. FIG. 6 is a schematic diagram illustrating examples of options 60.

RHOSTS 61 is an option for identifying the target host. For example, an IP address, a domain name, and the like may be used.

RPORT 62 is an option for identifying the service that has been started by the target host. For example, TCP port number, UDP port number, service name (SSH, RDP, or the like) and the like are used.

SRVHOST 63 is an option for identifying the current host when the current host provides a service to the target host at the time of execution of the attack step. For example, an IP address, a domain name, and the like may be used.

SRVPORT 64 is an option for identifying the service to be started by the current host when the current host provides the service to the target host at the time of execution of the attack step. For example, TCP port number, UDP port number, service name (SSH, RDP, or the like) and the like may be used.

FILENAME 65 is a file name used for output when generating an unauthorized file.

SESSION 66 is an option for identifying a connection (session) established with the already intruded host. For example, an identifier applied to each session may be used.

Options required for execution of each of the attack steps include a part of or all options described in FIG. 6. Furthermore, the options described in FIG. 6 are examples, and other options may be included as well. For example, it is also possible to include an option for identifying a user name and authentication information (password and the like) for using the service that has been started by the target host. For example, an identifier of a resource (Uniform Resource Identifier: URI, or the like) to be accessed by using the service that has been started by the target host may be included as well.

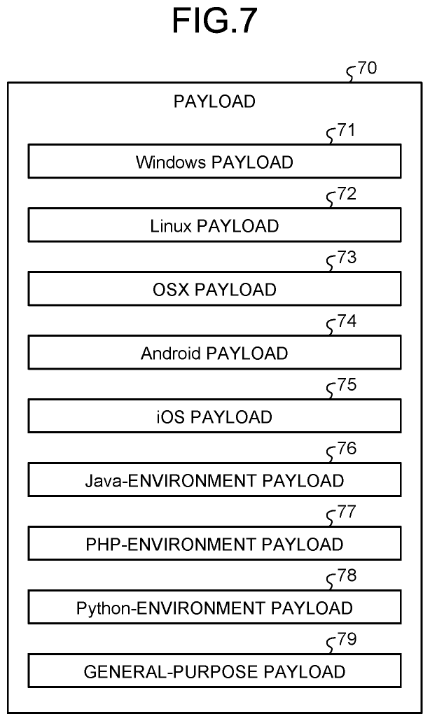

Next, details of the payload will be described. FIG. 7 is a schematic diagram illustrating an example of a payload 70. Note that the payload 70 is not limited to that illustrated in FIG. 7.

A Windows payload 71 is a payload targeted at a Windows OS.

A Linux (registered trademark) payload 72 is a payload targeted at a Linux OS.

An OSX (registered trademark) payload 73 is a payload targeted at a Mac OSX.

An Android (registered trademark) payload 74 is a payload targeted at an Android OS.

An iOS (registered trademark) payload 75 is a payload targeted at an iOS.

A Java-environment payload 76 is a payload that operates on a Java platform.

A PHP-environment payload 77 is a payload that operates on a PHP environment.

A Python-environment payload 78 is a payload that operates on a Python environment.

A general-purpose payload 79 is a payload that is not for any specific OS or environment.

While FIG. 7 illustrates a case in which the payloads are classified based on a specific OS or environment, the payloads may further be classified based on other perspectives. For example, the payload may be classified based on whether it is targeted at a specific CPU architecture (x86, x64, or the like).

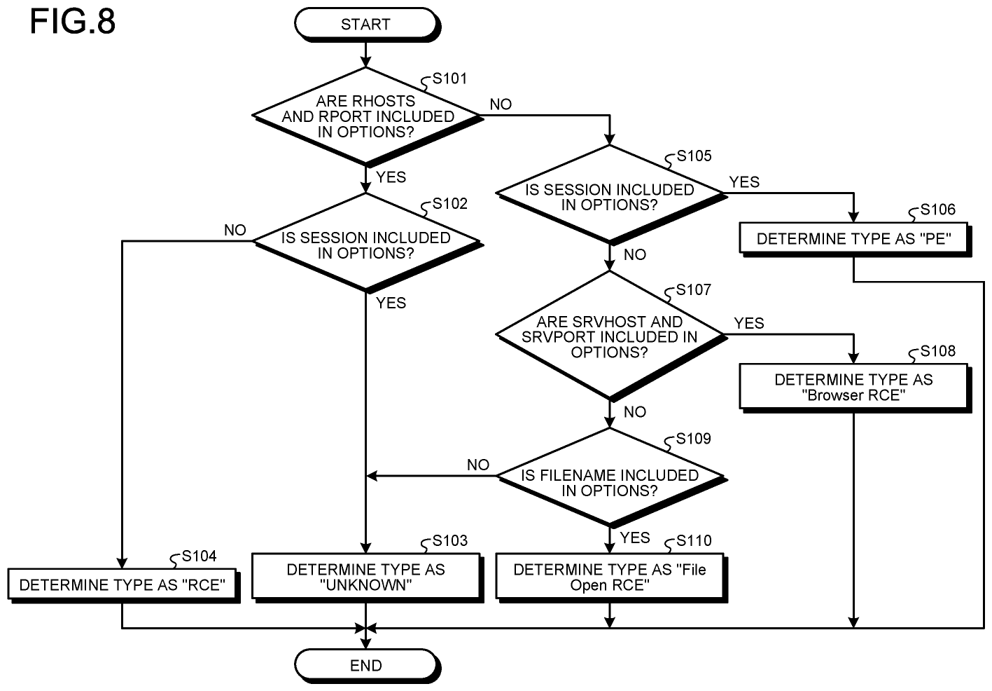

Next, processing of the analysis module 103 will be described. FIG. 8 is a flowchart illustrating an example of analysis processing performed by the analysis module 103.

The analysis module 103 determines whether RHOSTS and RPORT are included in the options of the target exploit (step S101). When RHOSTS and RPORT are included in the options (Yes at step S101), the analysis module 103 determines whether SESSION is included in the options (step S102).

When SESSION is included (Yes at step S102), the analysis module 103 outputs that the type of the exploit is “unknown” and ends the processing (step S103). This is because the options do not include SESSION along with RHOSTS and RPORT. When SESSION is not included (No at step S102), the analysis module 103 outputs that the type of the exploit is “RCE” and ends the processing (step S104).

When determined at step 5101 that RHOSTS and RPORT are not included in the options (No at step S101), the analysis module 103 determines whether SESSION is included in the options (step S105). When SESSION is included (Yes at step S105), the analysis module 103 outputs that the type of the exploit is “PE” and ends the processing (step S106).

When SESSION is not included in the options (No at step S105), the analysis module 103 determines whether SRVHOST and SRVPORT are included in the options (step S107). When SRVHOST and SRVPORT are included in the options (Yes at step S107), the analysis module 103 outputs that the type of the exploit is “Browser RCE” and ends the processing (step S108).

When SRVHOST and SRVPORT are not included in the options (No at step S107), the analysis module 103 determines whether FILENAME is included in the options (step S109). When FILENAME is included (Yes at step S109), the analysis module 103 outputs that the type of the exploit is “File Open RCE” and ends the processing (step S110). When FILENAME is not included (No at step S109), the analysis module 103 outputs that the type of the exploit is “unknown” and ends the processing (step S103).

As described above, the analysis module 103 is capable of classifying the types of the exploit based on the options included in the exploit. This allows the generation module 104 to generate the attack step information according to the type of the exploit.

While FIG. 8 illustrates a case in which the type of the exploit is determined depending on the options included in the argument information (setting information), the type may also be determined by using information other than the options. That is, as described above, the analysis module 103 may determine the types that are defined according to combinations of one or more pieces of setting information (for example, options and payloads included in the argument information). For example, the analysis module 103 may determine the type of the exploit depending on whether a specific payload is included.

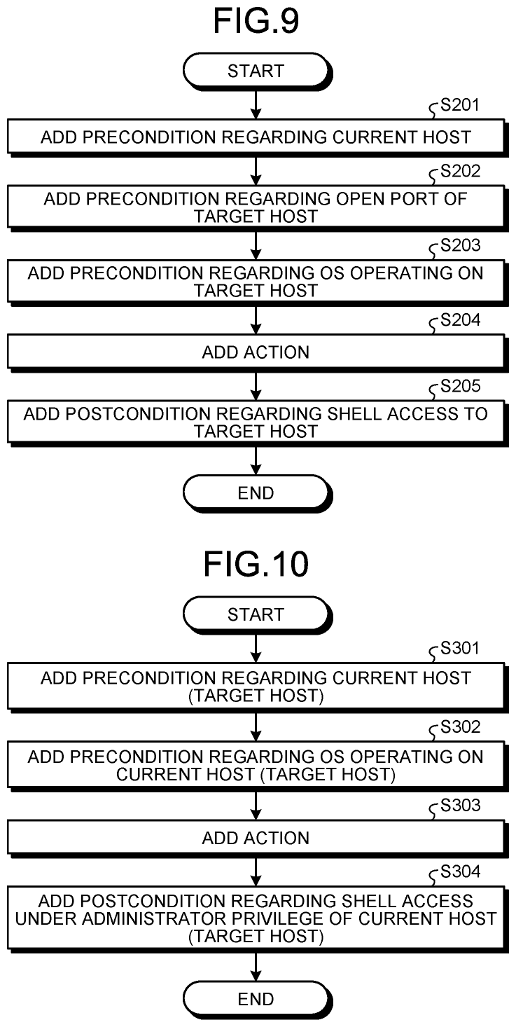

Next, generation processing of the attack step information performed by the generation module 104 will be described. FIG. 9 to FIG. 12 are flowcharts illustrating examples of the generation processing when the respective types of the exploit are determined as RCE, PE, Browser RCE, and File Open RCE. As long as it is possible to generate the attack step information according to the types, generation processing other than those illustrated in FIG. 9 to FIG. 12 may be used as well.

An example of generation processing when the type of the exploit is determined as RCE will be described with reference to FIG. 9.

The generation module 104 adds the precondition regarding the current host to the attack step information (step S201). For example, the generation module 104 adds the precondition “have shell access privilege for current host”.

The generation module 104 adds the precondition regarding the open port of the target host to the attack step information (step S202). For example, when TCP/3389 is set as the default value of RPORT option, the generation module 104 adds the precondition “TCP/3389 port of target host is open”.

The generation module 104 adds the precondition regarding the OS operating on the target host to the attack step information (step S203). For example, when the Windows payload is included in the payload, the generation module 104 adds the precondition “Windows OS is operating on the target host”.

The generation module 104 adds the action corresponding to the exploit to the attack step information (step S204).

The generation module 104 adds, to the attack step information, the postcondition regarding the shell access to the target host (step S205). For example, the postcondition “have shell access privilege for target host” is added.

An example of the generation processing in a case in which the type of the exploit is determined as PE will be described with reference to FIG. 10.

The generation module 104 adds the precondition regarding the current host (target host) to the attack step information (step S301). For example, the generation module 104 adds the precondition “have shell access privilege for target host”.

The generation module 104 adds the precondition regarding the OS operating on the current host (target host) to the attack step information (step S302). For example, when the Windows payload is included in the payload, the generation module 104 adds the precondition “Windows OS is operating on the target host”.

The generation module 104 adds the action corresponding to the exploit to the attack step information (step S303).

The generation module 104 adds, to the attack step information, the postcondition regarding the shell access under the administrator privilege of the target host (step S304). For example, the generation module 104 adds the postcondition “have shell access privilege under administrator privilege of target host”.

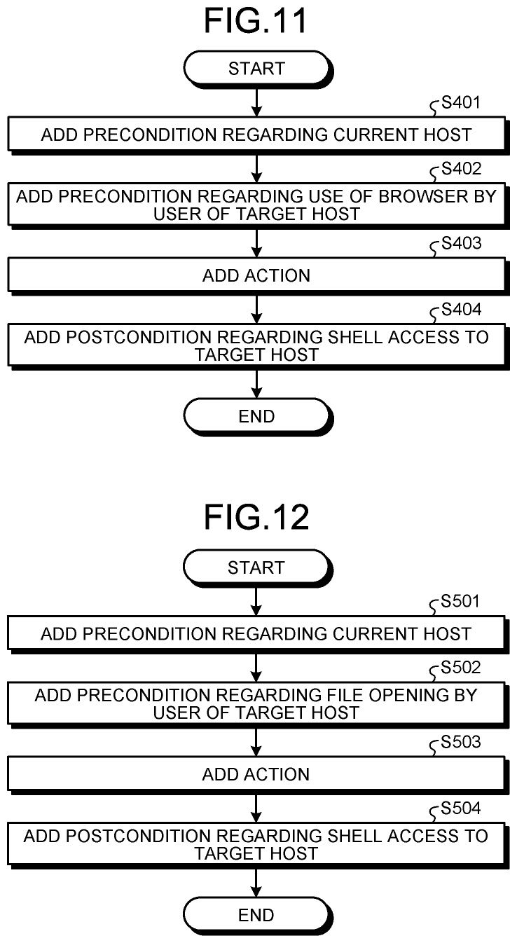

An example of the generation processing in a case in which the type of the exploit is determined as Browser RCE will be described with reference to FIG. 11.

The generation module 104 adds the precondition regarding the current host to the attack step information (step S401). For example, the generation module 104 adds the precondition “have shell access privilege for current host”.

The generation module 104 adds, to the attack step information, the precondition regarding the use of browser by the user of the target host (step S402). For example, the generation module 104 adds the precondition “user using target host accesses a website with a browser”.

The generation module 104 adds the action corresponding to the exploit to the attack step information (step S403).

The generation module 104 adds, to the attack step information, the postcondition regarding the shell access to the target host (step S404). For example, the generation module 104 adds the postcondition “have shell access privilege for target host”.

An example of the generation processing in a case in which the type of the exploit is determined as File Open RCE will be described with reference to FIG. 12.

The generation module 104 adds the precondition regarding the current host to the attack step information (step S501). For example, the generation module 104 adds the precondition “have shell access privilege for current host”.

The generation module 104 adds, to the attack step information, the precondition regarding file opening by the user of the target host (step S502). For example, the generation module 104 adds the precondition “user using target host opens file”.

The generation module 104 adds the action corresponding to the exploit to the attack step information (step S503).

The generation module 104 adds, to the attack step information, the postcondition regarding the shell access to the target host (step S504). For example, the generation module 104 adds the postcondition “have shell access privilege for target host”.

As described above, it is possible with the embodiment to generate the information (attack step information) used for the penetration test more efficiently.

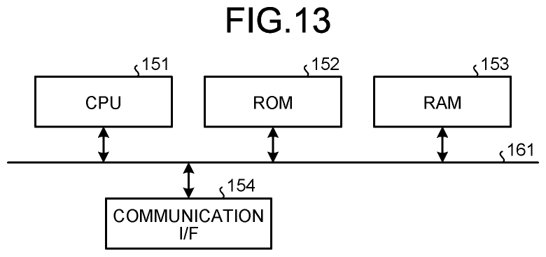

Next, the hardware configuration of the information processing device 100 according to the embodiment will be described with reference to FIG. 13. FIG. 13 is an explanatory diagram illustrating an example of the hardware configuration of the information processing device 100 according to the embodiment.

The information processing device 100 according to the embodiment includes a control unit such as a CPU 151, a storage device such as a Read Only Memory (ROM) 152, a RAM 153, a communication I/F 154 that is connected to a network for implementing communication, and a bus 161 that connects each of the units.

The information processing device 100 may physically be configured with one piece of hardware or may be configured as a logical unit on a cloud environment including at least one or more server devices.

The computer program executed in the information processing device 100 according to the embodiment is provided by being loaded in advance in the ROM 152 or the like.

The computer program executed in the information processing device 100 according to the embodiment may be configured to be provided as a computer program product in a form of installable or executable file that is recorded on a computer readable recording medium such as a Compact Disk Read Only Memory (CD-ROM), a Flexible Disk (FD), a Compact Disk Recordable (CD-R), or a Digital Versatile Disk (DVD).

Furthermore, the computer program executed in the information processing device 100 according to the embodiment may be configured to be stored on a computer connected to a network such as the Internet and provided by being downloaded via the network. Furthermore, the computer program executed in the information processing device 100 according to the embodiment may be provided or distributed via a network such as the Internet.

The computer program executed in the information processing device 100 according to the embodiment may cause a computer to function as each of the units of the information processing device 100 described above. As for the computer, the CPU 151 can load and execute the computer program on a main memory from a computer readable recording medium.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing device comprising:
one or more processors configured to:
acquire one or more pieces of setting information of a module used for an attack aimed at a target of a penetration test;
analyze the acquired setting information to determine a type of the attack; and
generate attack step information that defines a condition and a procedure of the attack according to the determined type.

2. The device according to claim 1, wherein the one or more processors are configured to determine the type defined according to a combination of the one or more pieces of setting information.

3. The device according to claim 1, wherein the attack step information includes a precondition required before executing the attack, information indicating an action of the module, and a postcondition to be satisfied after executing the attack.

4. The device according to claim 1, wherein the one or more processors are configured to determine the type that indicates one of an attack exploiting a vulnerability of a service of a remote host, an attack exploiting a vulnerability of a browser, an attack for making an intrusion when an unauthorized file is opened, and an attack for escalating a privilege for an already intruded target to an administrator privilege.

5. The device according to claim 1, further comprising:
a memory configured to store therein the setting information, wherein
the one or more processors are configured to acquire, from the memory, the setting information corresponding to designated identification information of the module.

6. An information processing method comprising:
acquiring one or more pieces of setting information of a module used for an attack aimed at a target of a penetration test;
analyzing the acquired setting information to determine a type of the attack; and
generating attack step information that defines a condition and a procedure of the attack according to the determined type.

7. A computer program product comprising a computer readable medium including programmed instructions, the instructions causing a computer to execute:
acquiring one or more pieces of setting information of a module used for an attack aimed at a target of a penetration test;
analyzing the acquired setting information to determine a type of the attack; and
generating attack step information that defines a condition and a procedure of the attack according to the determined type.
